(19) United States
(12) Patent Application Publication
(10) Pub. No.: US 2007/0291510 A1
(43) Pub. Date: Dec. 20, 2007

(54) Backlight module and light guide plate thereof

(75) Inventor: Ping-Yeng Chen, Feng Yuan City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/453,138

(22) Filed: Jun. 15, 2006

(51) Int. Cl. F21V 7/04

(52) U.S. Cl. 362/618

(57) ABSTRACT

A backlight module includes a light guide plate, at least one point light source, and an optical film. The light guide plate has a light outputting surface and a light reflecting surface opposing to the light outputting surface. A plurality of dots are indented on the light outputting surface, and a plurality of grooves are formed parallel to each other on the light reflecting surface. The propagation directions of most of the emitting light rays of the point light source are substantially parallel to the direction of the grooves. The optical film is provided with refraction elements arranged in a direction perpendicular to the direction of the grooves.

### BACKGROUND OF THE INVENTION

(a) Field of the Invention

The invention relates to a backlight module, and particularly to a backlight module with a light guide plate having specific-shaped grooves and non-diffusive dots.

(b) Description of the Related Art

FIG. 1 shows a typical schematic structure of a conventional backlight module utilizing a diffusive light guide plate that requires two prism sheets. Light-guiding structures 2 formed on the bottom surface of the light guide plate 1 reflect or refract light rays. While the light rays from a light source 3 hit the light-guiding structures 2, bright spots will be generated, i.e. the incident light is deflected by the light guiding structures 2 so as to exit the light outputting surface of the light guide plate 1. Although the light rays deflected by the light-guiding structures 2 are diffusive, the advantage of the above light guiding mechanism is that, no matter how large the incident angle of incoming light, the angle between the normal direction of the light outputting surface of the light guide plate 1 and deflected light can be reduced to destroy total reflections to let the light exit the light guide plate 1. Specifically, the light rays diffusively exit the light guide plate 1 by the light guiding structures 2 and then are converged by a diffusion sheet 4 and two prism sheets (a first prism sheet 5 and a second prism sheet 6).

The characteristic of the light guide plate 1 is to refract incident light rays so as to guide the light rays to exit the light guide plate 1 as much as possible. By using the diffusion sheet 4 and the two prism sheets (the first prism sheet 5 and the second prism sheet 6), most of the light rays coming out from the light guide plate 1 are converged to have included angles with respect to the normal direction of the light outputting surface smaller than or equal to 25 degrees. The angle of 25 degrees is in the case of using the prism sheet fabricated by 3M Corporation. The angle may be different for other prism design or materials. The light guide plate 1 is simply designed to refract incident light rays to guide them to exit the light guide plate 1, without any particular design on light exit angles. Thus, the light guide plate 1 is inefficient in energy because the widespread light exit angles cause a portion of unused light rays. Moreover, the light rays would have multiple passes between the light guide plate 1 and the two prism sheets 5 and 6 to result in energy loss. Hence, it is difficult to have brightness enhancement, and the luminance of the light guide plate 1 as well as the efficiency of light-guiding is low.

### BRIEF SUMMARY OF THE INVENTION

In order to solve the above mentioned drawbacks, an object of the invention is to provide a backlight module that allows light rays exiting a light guide plate to propagate at a narrow range of azimuth angles.

Another object of the invention is to modify the structure of a light guide plate to allow the propagation directions of most of the light rays exiting the light guide plate to be substantially parallel to the direction of grooves formed on the light guide plate to increase the light guiding efficiency, so that a backlight module incorporating the light guide plate has high luminance efficiency and good uniformity.

Another object of the invention is to provide a light guide plate that requires only one optical film (prism sheet) to deflect light rays so as to have a thinner backlight module compared to the conventional one that uses two prism sheets.

According to the invention, a backlight module includes a light guide plate, at least one point light source, and an optical film. The light guide plate has a light outputting surface and a light reflecting surface opposing to the light outputting surface. A plurality of dots are formed on the light outputting surface, and a plurality of grooves are formed on the light reflecting surface where each groove is provided parallel to each other. The point light source is provided on one side of the light guide plate and next to the ends of the grooves, and the propagation directions of most of the emitting light rays of the point light source are substantially parallel to the direction of the grooves. The optical film is provided neighboring the light outputting surface of the light guide where a plurality of refraction elements are formed, with the refraction elements being arranged in a direction perpendicular to the direction of the grooves.

Through the design of the invention, since the grooves are provided continuously or discretely on the light reflecting surface of the light guide plate, the light rays from the point light source may propagate to the whole light guide plate by the guidance of the grooves. Thus, the azimuth angles of the propagation directions of the light rays can be adjusted by the guidance of the grooves and limited in a narrow range of angles. Further, since the dots will not change or slightly change the azimuth angles of the propagation directions, the light rays deflected by the dots and then exiting the light guide plate may still propagate at a narrow range of azimuth angles. Therefore, the light rays exiting from the light guide plate are similar to those exiting from a linear light source.

According to the implement of the invention, since the light rays exiting the light guide plate propagate at a narrow range of azimuth angles, the luminance efficiency in the normal direction of the light outputting surface of the light guide plate is excellent.

### BRIEF DESCRIPTION OF THE DRAWINGS

FIG. 1 shows a typical schematic structure of a conventional backlight module utilizing a diffusive light guide plate.

FIG. 2 shows a schematic diagram illustrating a light guide plate according to the invention.

FIG. 3 shows a schematic diagram illustrating one type of V-shaped grooves formed on the light guide plate according to the invention.

FIG. 4 shows a schematic diagram illustrating another type of V-shaped grooves formed on the light guide plate according to the invention.

FIG. 5 shows a schematic structure of a dot according to the invention.

FIG. 6 shows another schematic structure of a dot according to the invention.

FIG. 7 shows another schematic structure of a dot according to the invention.

FIG. 8 shows another schematic structure of a dot according to the invention.

FIG. 9 shows another schematic structure of a dot according to the invention.

FIG. 10 shows another schematic structure of a dot according to the invention.

FIG. 11 shows a schematic diagram illustrating the position of the light source and the direction of the V-shaped grooves according to the invention.

FIG. 12 shows a schematic diagram illustrating another position of the light source and the direction of the V-shaped grooves according to the invention.

FIG. 13 shows a schematic structure of the backlight module according to the invention.

FIG. 14 shows a schematic structure of the backlight module for optical simulation according to the invention.

FIGS. 15A and 15B show schematic diagrams illustrating simulation results in the area A shown in FIG. 14 respectively for a conventional diffusive type light guide plate and a light guide plate of the invention having grooves only on one surface.

FIGS. 16A and 16B show schematic diagrams illustrating simulation results in the area B shown in FIG. 14 respectively for a conventional diffusive type light guide plate and a light guide plate of the invention having grooves only on one surface.

FIGS. 17A and 17B show schematic diagrams illustrating simulation results in the area C shown in FIG. 14 respectively for a conventional diffusive type light guide plate and a light guide plate of the invention having grooves only on one surface.

FIG. 18 shows a schematic diagram illustrating a V-shaped planar zone on the light reflecting surface of the light guide plate.

FIG. 19 shows a schematic diagram illustrating a V-shaped surface-treated zone on the light outputting surface of the light guide plate.

FIG. 20 shows a schematic diagram illustrating a light guide plate having grooves and notches respectively on two opposing surfaces.

FIGS. 21A and 21B show schematic diagrams illustrating simulation results in the area A respectively for the light guide plate having grooves only on one surface and that having grooves and notches respectively on two opposing surfaces.

FIGS. 22A and 22B show schematic diagrams illustrating simulation results in the area B respectively for the light guide plate having grooves only on one surface and that having grooves and notches respectively on two opposing surfaces.

FIGS. 23A and 23B show schematic diagrams illustrating simulation results in the area C respectively for the light guide plate having grooves only on one surface and that having grooves and notches respectively on two opposing surfaces.

FIGS. 24A and 24B shows a schematic diagram illustrating measurement comparison at the same relative position between a conventional light guide plate and a light guide plate have grooves and notches respectively on two opposing surfaces according to the invention.

### DETAILED DESCRIPTION OF THE INVENTION

Detail descriptions of the structure and elements according to the invention will be provided in the following in order to make the invention thoroughly understood.

Referring to FIG. 2, a backlight module of the invention includes a light guide plate 10 and a point light source 20. The light guide plate 10 has a light outputting surface 11 and a light reflecting surface 12 opposing to the light outputting surface 11. A plurality of dots 111 are formed on the light outputting surface 11, and a plurality of V-shaped grooves 121 are formed parallel to each other on the light reflecting surface 12.

A point light source 20 is provided on or near one side of the light guide plate 10 and next to the ends of the grooves 121. Hence, the propagating directions of most of the light rays, originally outputted from the point light source 20 and then projected onto the light reflecting surface 12, are substantially parallel to the direction of the V-shaped grooves through the guidance of the V-shaped grooves.

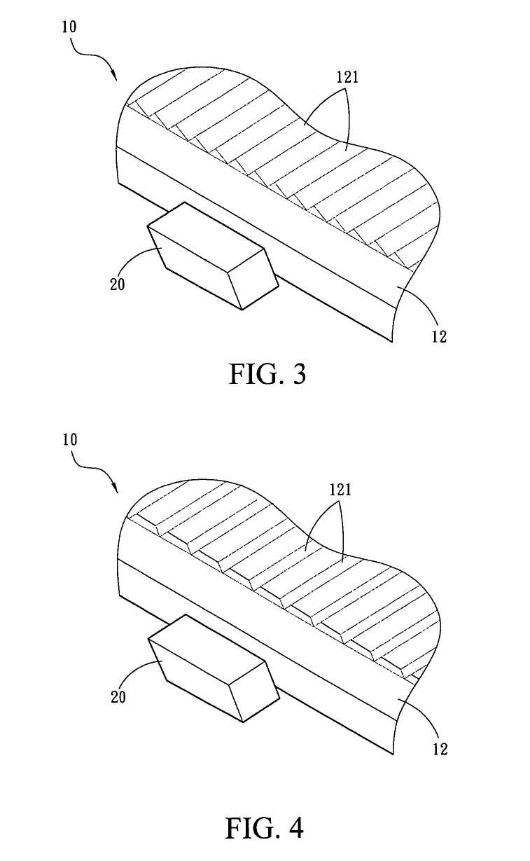

FIGS. 3 and 4 show schematic structures of the V-shaped grooves 121 of the light guide plate 10 according to the invention. For example, the V-shaped grooves 121 can be continuously provided as shown in FIG. 3, where each two grooves 121 are next to each other. Alternatively, the V-shaped grooves 121 can be discretely provided as shown in FIG. 4, where a space is formed between two adjacent grooves 121. Further, a preferred vertex angle of the V-shaped groove 121 is between 80 degrees and 120 degrees. Certainly, this range is not limited and can be selected in accordance with the size of the light guide plate 10 and the position of the point light source 20.

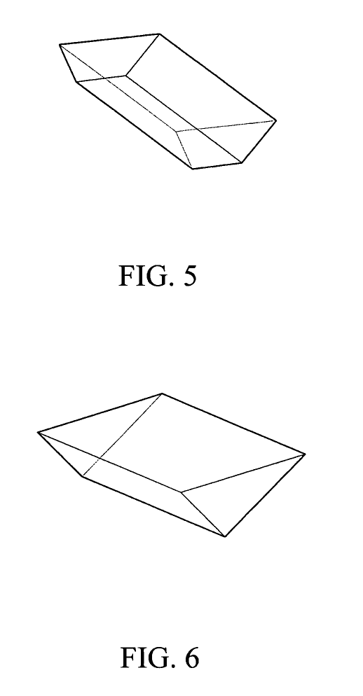

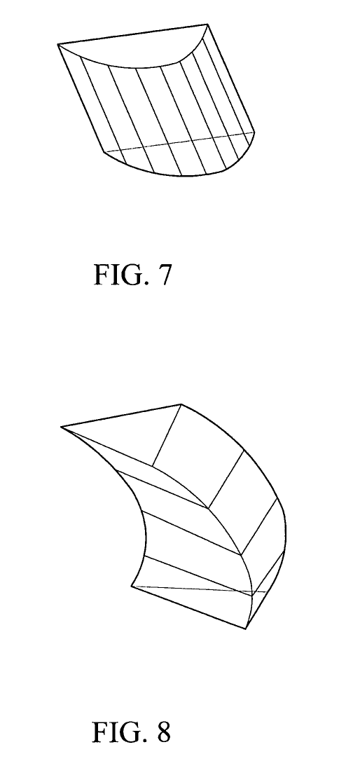

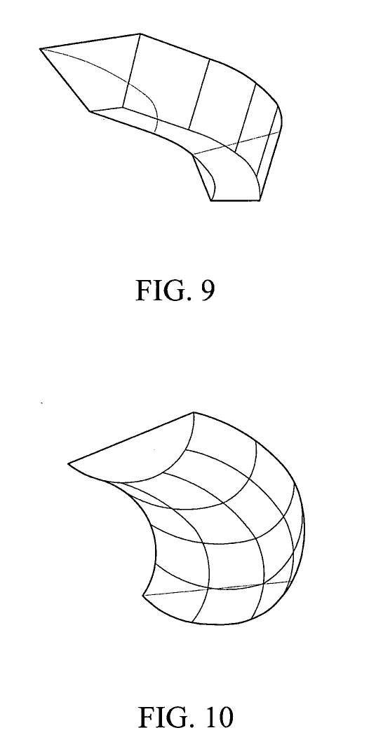

As shown in FIG. 2, the dots 111 are indented on the light outputting surface 11 to deflect the inner light rays and allow them to exit the light outputting surface 11. The distribution density of the dots 111 on the light outputting surface 11 increases along the direction away from the point light source 20. According to the invention, the dots 111 may be rectangular dots that do not change the azimuth angles of the exiting light rays, or alternatively the dots 111 may be arc-shaped dots with arc angles smaller than 20 degrees that diffuse the exiting light rays and slightly change their azimuth angles. The rectangular dots are indented on the light outputting surface 11 and have a rectangular light incident surface facing the light source 20. The cross-section of the indented structure may be a trapezoid shape shown in FIG. 5, a triangular shape shown in FIG. 6, or an arc shape shown in FIG. 7. The arc-shaped dots are indented on the light outputting surface 11 and have an arc-shaped light incident surface facing the light source 20 in which the angle of the arc is smaller than 20 degrees. The cross-section of the indented structure may be a triangular shape shown in FIG. 8, a trapezoid shape shown in FIG. 9, or an arc shape shown in FIG. 10.

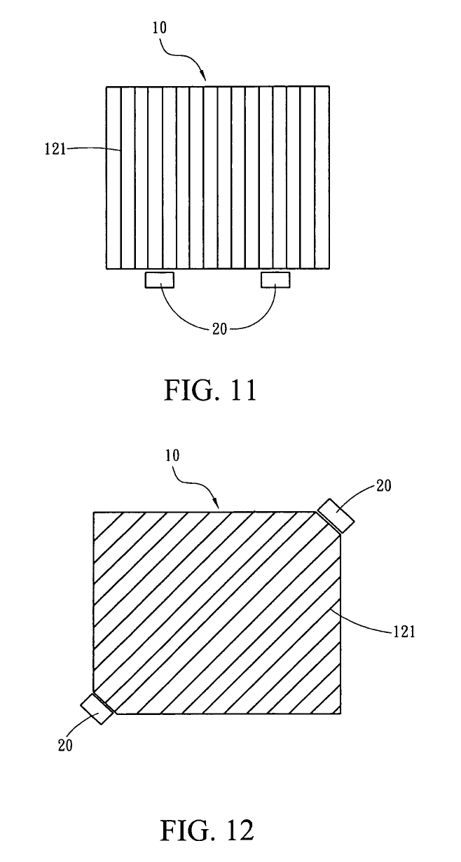

FIGS. 11 and 12 show schematic diagrams illustrating the design of the light guide plate 10 in combination with a plurality of point light sources 20. The relationship between the positions of the point light sources 20 and the direction of the V-shaped grooves 121 are shown in FIGS. 11 and 12. As shown in FIG. 11, two point light sources 20 are provided on the same side of the light guide plate 10 and point to the same direction. The propagating directions of most of the light rays, originally outputted from the point light sources 20 and then projected onto the light reflecting surface, are substantially parallel to the direction of the V-shaped grooves 121. On the other hand, as shown in FIG. 12, two point light sources 20 facing each other are provided separately on two opposite sides of the light guide plate 10. The propagation directions of most of the light rays are also substantially parallel to the direction of the V-shaped grooves 121.

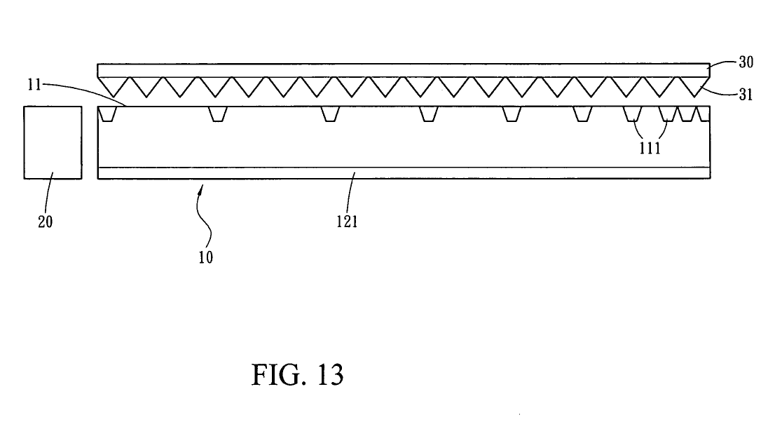

FIG. 13 shows a schematic cross-section of the backlight module according to the invention. Referring to FIG. 13, an optical film 30 is provided neighboring the light outputting surface 11 of the light guide plate 10, and a plurality of prismatic structures 31 are formed on the surface of the optical film 30 facing the light outputting surface 11 and are arranged to be perpendicular to the direction of the V-shaped grooves 121, i.e. perpendicular to the direction having the highest light intensity. Hence, the light rays can be directed by the optical film 30 to prorogate along accepted viewing directions of a finished display.

According to the invention, since the grooves 121 are provided continuously or discretely on the light reflecting surface 12 of the light guide plate 10, the light rays outputting from the point light source 20 may propagate to the whole light guide plate 10 by the guidance of the V-shaped grooves 121. Thus, the azimuth angles of the propagation directions of the light rays that will arrive at any position of the light outputting surface 11 can be limited in a narrow range of angles. Then, the light rays are deflected by the dots 111 to exit the light guide plate 10, and the deflected light rays are further directed by the optical film 30 to prorogate along accepted viewing directions of a finished display. Therefore, the light rays exiting from the light guide plate 10 are similar to those exiting from a linear light source.

Though the implement of the invention may result in a slightly narrow viewing angle, its luminance efficiency, such as compared with the conventional two-prism-sheets design, is considerablely increased because of the narrow range of azimuth angles.

The brightness enhancement effect of the invention will be further illustrated by the following examples.

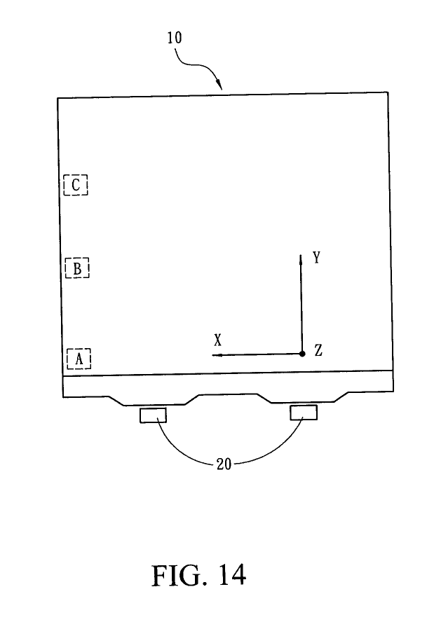

FIG. 14 shows a schematic structure of the backlight module for optical simulation to verify the brightness enhancement effect of the invention. The backlight module has two point light sources 20 provided on the same side of the light guide plate 10. One side of the light guide plate 10 is divided into three areas A, B and C with respect to the distance apart from the point light sources 20. The areas A, B and C are provided to form a straight line. The simulation example compares the conventional diffusive type light guide plate 1 with the light guide plate 10 of the invention having continuously-formed V-shaped grooves 121, given that the vertex angle of each V-shaped groove is 110 degrees and its two base angles are both 35 degrees. Besides, the detection surface is provided inside the light guide plate 1 and 10 to observe the light propagation directions.

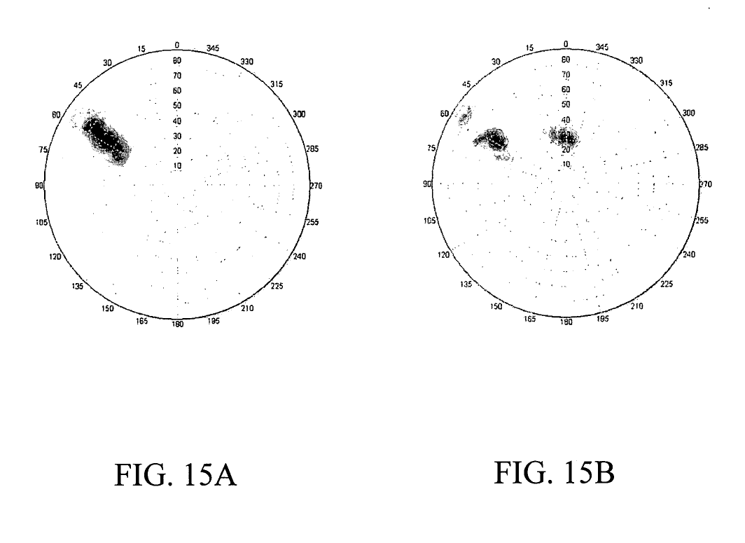

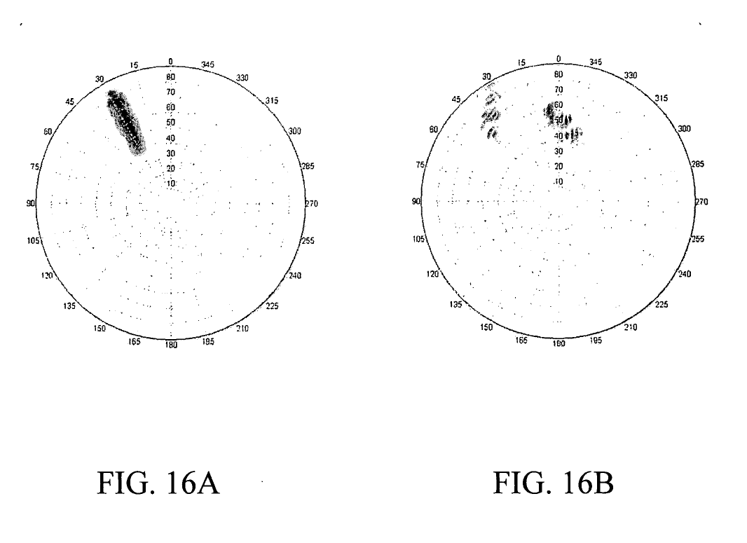

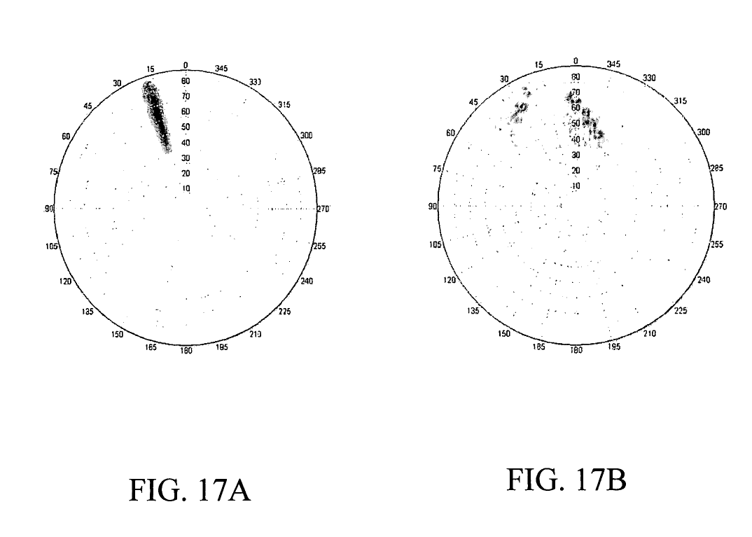

FIGS. 15A-17B show schematic diagrams illustrating simulation results in the areas A, B and C for a conventional diffusive type light guide plate 1 and a light guide plate 10 of the invention having V-shaped grooves 121 only on one surface. FIGS. 15A, 16A and 17A show the results from the conventional light guide plate while FIGS. 15B, 16B and 17B show the results from the design according to the invention. From the results shown in above figures, it is clearly seen the light rays in the light guide plate 10 tend to propagate toward the directions having substantial 0 degree azimuth angle, as compared with the conventional diffusive type light guide plate 1.

Certainly, even the propagation directions of light rays in the light guide plate 10 are confined to a narrow range of azimuth angles, the dots 111 are still required to let the light rays exit the light guide plate 10. According to the invention, the dots 111 may be rectangular dots that do not change the azimuth angles of the exiting light rays, or alternatively the dots 111 may be arc-shaped dots with arc angles smaller than 20 degrees that allows the exiting light rays to have slightly diffuse azimuth angles. The rectangular dots are indented on the light outputting surface 11 and have a rectangular light incident surface facing the light source. The arc-shaped dots are indented on the light outputting surface 11 and have an arc-shaped light incident surface facing the light source.

On the other hand, some light rays propagate at a specific azimuth angle may directly pass through the light guide plate 10 after deflected by the V-shaped grooves 121, and, in that case, the deflected light rays may be led to a perpendicular viewing direction by the optical film 30 to result in a bright zone formed on two sides of the light guide plate 10, particularly appearing in the area A defined in FIG. 14. For example, in case the vertex angle of the V-shaped groove 121 is about 120 degrees, the resulting V-shaped bright zone may have a vertex angle of about 100 degrees. The V-shaped bright zone means there is a V-word-type bright area laying on the surface if viewing from the normal direction of the surface. Besides, the smaller the vertex angle of the V-shaped groove 121 is, the larger the vertex angle of the V-shaped bright zone is.

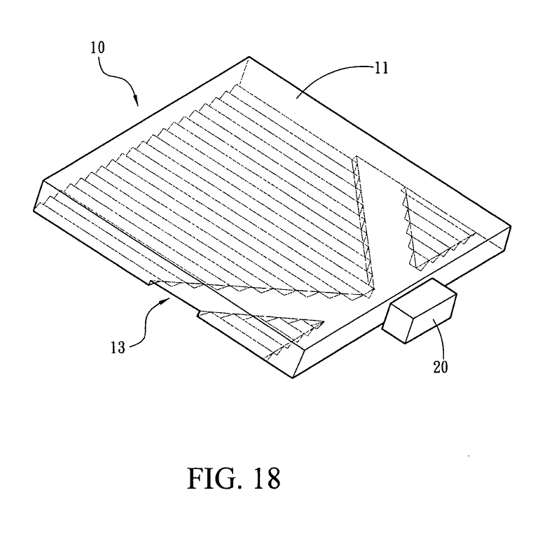

Therefore, the invention also provides a design to eliminate aforesaid bright zone formed on the light guide plate 10. For example, a V-shaped planar zone 13 may be defined on the light reflecting surface 12 corresponding to the position of the V-shaped bright zone, as shown in FIG. 18. The V-shaped planar zone 13 means there is a V-word-type planar area without the formation of the V-shaped grooves 121 if viewing from the normal direction of the light reflecting surface 12. The apex of the V-shaped planar zone 13 is close to the point light source 20, and the preferred vertex angle of the V-shaped planar zone 13 is between 90 degrees and 100 degrees. Through the design of the example, the light rays propagate at that specific azimuth angle will not be deflected by the V-shaped grooves 121 while hitting the V-shaped planar zone 13 so as to effectively prevent the creation of the bright zone.

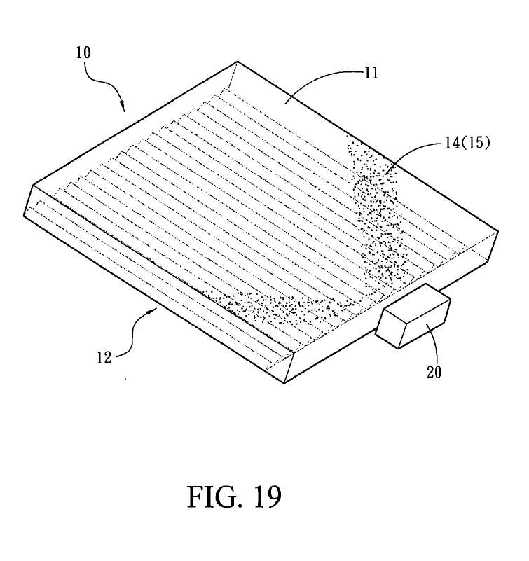

FIG. 19 illustrates another example where a surface treatment is made on an area of the light outputting surface 11 corresponding to the bright zone so as to diffuse light rays. Likewise, a plurality of dots are formed on the light outputting surface 11 although they are not shown in the figure. Referring to FIG. 19, a V-shaped sandblasting zone 14 is defined on the light outputting surface 11 and the apex of the V-shaped sandblasting zone is close to the point light source 20. Alternatively, the V-shaped sandblasting zone 14 may be replaced with a V-shaped densely-dot-distributed zone 15 having a higher dot distribution density than its neighboring zones, and the apex of the V-shaped densely-dot-distributed zone 15 is close to the point light source 20. Through the design of these examples, the light rays propagate at that specific azimuth angle will be dispersed by the sandblasting zone or the densely-dot-distributed zone so as to effectively prevent the creation of the bright zone. Also, the preferred vertex angle of the V-shaped sandblasting zone or the densely-dot-distributed zone is between 90 degrees and 100 degrees.

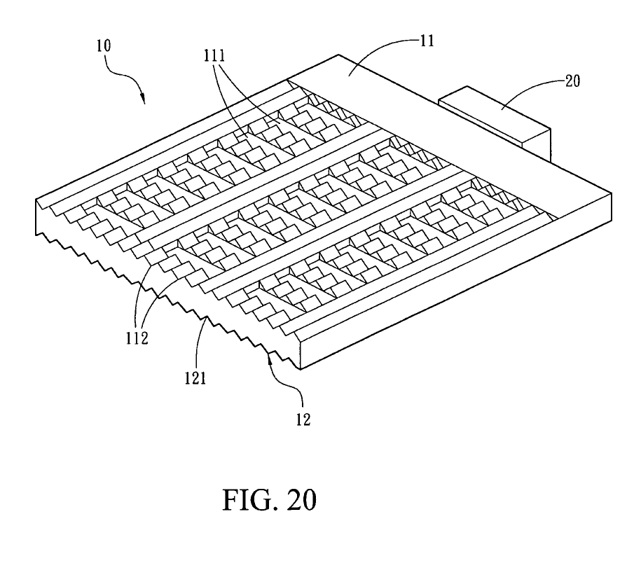

FIG. 20 illustrates another example where a plurality of V-shaped notches 112 are formed on the light outputting surface 11 and arranged parallel to the direction of the V-shaped grooves 121 on the light reflecting surface 12. Similar to the V-shaped grooves 121 on the light reflecting surface 12, the V-shaped notches may be provided continuously or discretely on the light outputting surface 11. Thus, the light rays propagate at that specific azimuth angle will be deflected by the V-shaped notches 112 after deflected by the V-shaped grooves 121 so as to effectively prevent the creation of the bright zone. Further, the light control mechanism for the V-shaped notches 112 is similar to that of the V-shaped grooves 121 to achieve the same effects.

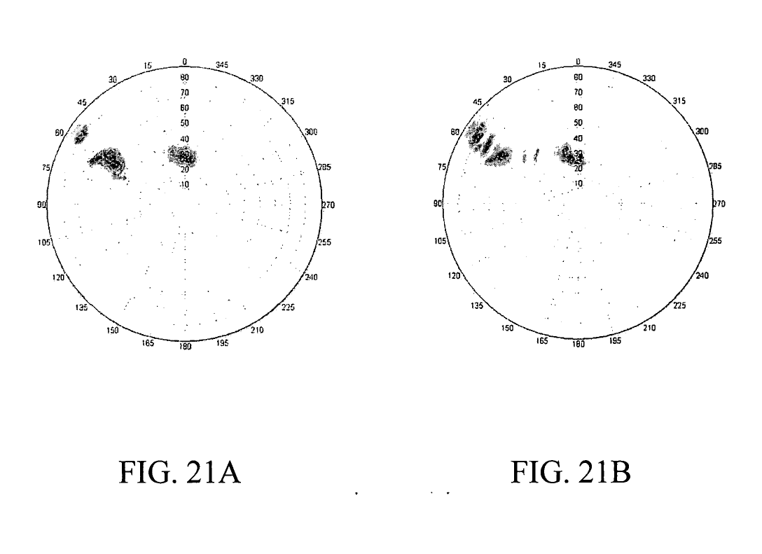

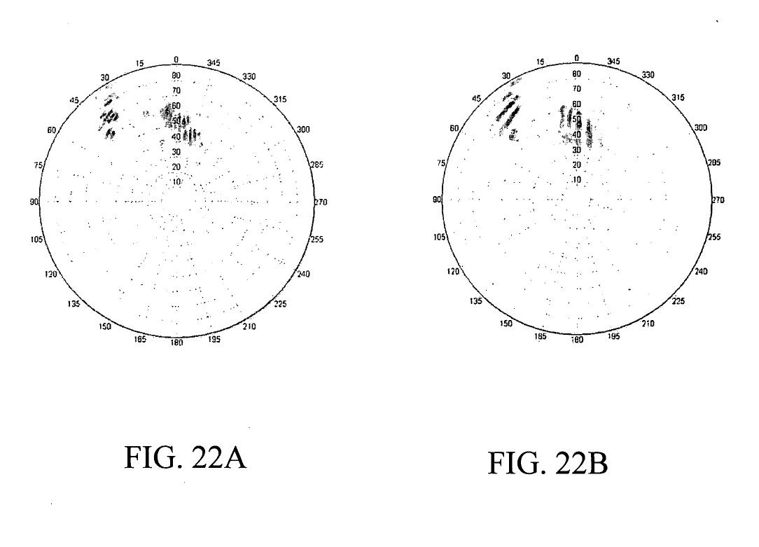

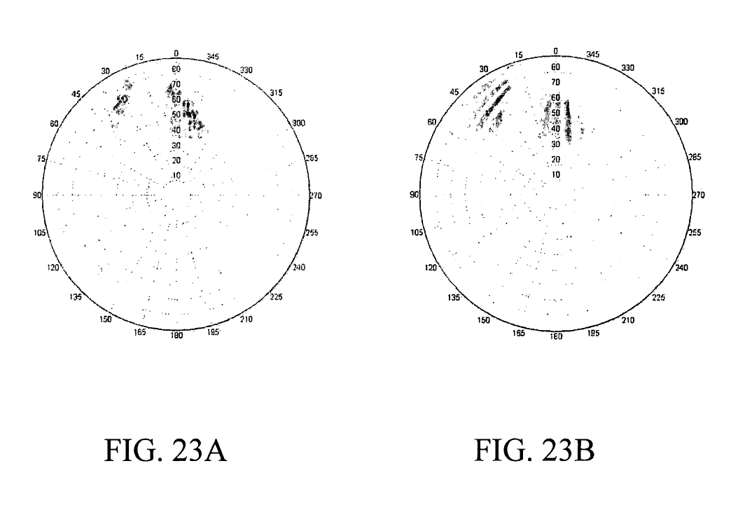

FIGS. 21A-23B show schematic diagrams illustrating simulation results in the areas A, B and C in the case of the above examples. FIGS. 21A, 22A and 23A show the results for the light guide plate having grooves only on one surface, as shown in FIG. 13, while FIGS. 21B, 22B and 23B show the results for the light guide plate having grooves and notches respectively on two opposing surfaces, as shown in FIG. 20. The simulation conditions are set identical to those illustrated in FIG. 14. An optical simulation software is used to verify the design, where the conditions are given that the number of the light rays are 1000000, and that the V-shaped grooves 121 and notches 112 are continuously provided and have triangular cross-sections, with their vertex angle being 110 degrees and two base angles being 35 degrees. Besides, the detection surface is provided inside the light guide plate 10 to observe the light propagation directions.

From the results shown in FIGS. 21A-23B, it is clearly seen the light rays in the light guide plate 10 may propagate at an azimuth angle of substantial 0 degree, no matter whether the light guide plate 10 has grooves only on one surface or has grooves and notches on two opposing surfaces. However, as shown in FIG. 21A, in case of having grooves only on one surface, the light rays propagating at 0 degree azimuth angle may make an elevation angle of about 30 degrees with the detection surface, and thus a bright zone is created in the area A after the light rays exiting the light guide plate 10 are led to a perpendicular viewing direction by the optical film 30. However, in case of having grooves and notches on two opposing surfaces, the light rays propagating at 0 degree azimuth angle in the area A will continue to have total internal reflections in the light guide plate 10 until reaching the dots 111 due to the effect of the V-shaped notches 112 so as to effectively prevent the creation of the bright zone.

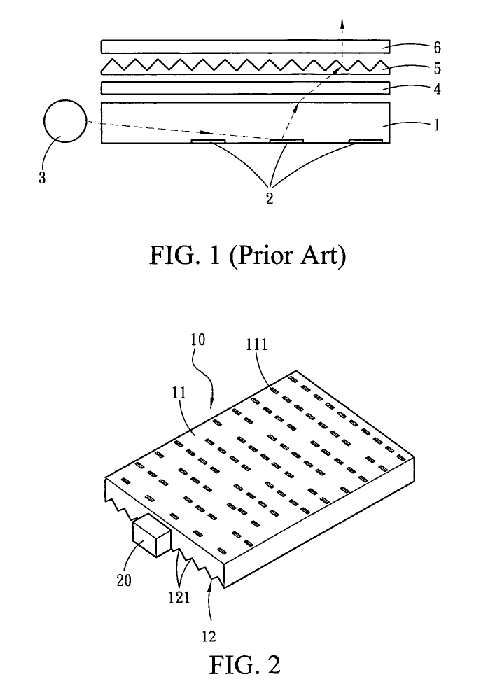

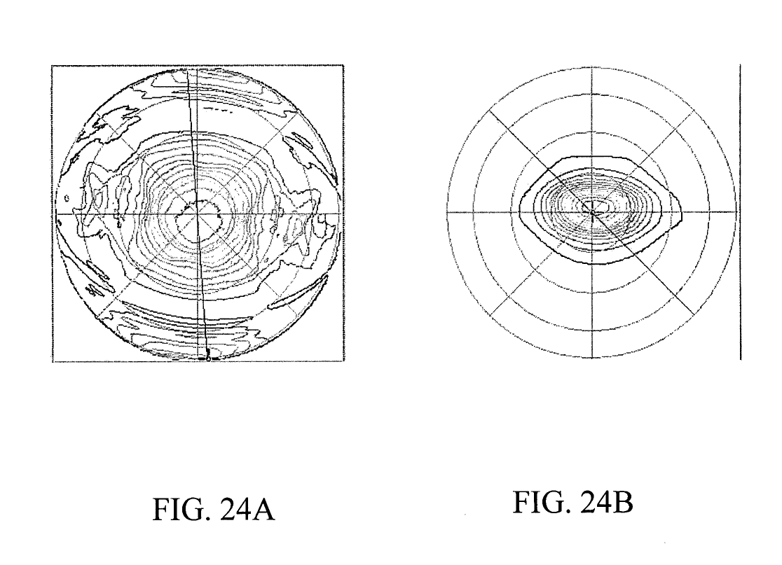

FIGS. 24A and 24B show schematic diagrams illustrating the detection results respectively for a conventional backlight module and the inventive backlight module. FIG. 24A shows the result for the conventional backlight module manufactured by general etching processes, such as shown in FIG. 1. The conventional backlight module includes a light guide plate 1, a diffusion sheet 4, and two prism sheets (the first prism sheet 5 and the second prism sheet 6). FIG. 24B shows the result for the inventive backlight module, which includes a light guide plate 10 having grooves and notches respectively on two opposing surfaces, an optical film 30, and a diffusion sheet. A measure for the light dispersion angles with respect to the same positions on the light guide plate 1 and 10 is performed by a conoscope. From the results, it is clearly found the luminance efficiency of the light guide plate 10 according to the invention is obviously higher than that of the conventional light guide plate 1.

To sum up, through the design of the invention, since the grooves 121 are provided continuously or discretely on the light reflecting surface of the light guide plate 10, the light rays from the point light source 20 may propagate to the whole light guide plate 10 by the guidance of the grooves 121. Thus, the azimuth angles of the propagation directions of the light rays can be adjusted by the guidance of the grooves 121 and limited in a narrow range of angles. Further, since the dots 111 will not change or slightly change the azimuth angles of the propagation directions, the light rays deflected by the dots 111 and then exiting the light guide plate 10 may still propagate at a narrow range of azimuth angles. Therefore, the light rays exiting from the light guide plate 10 are similar to those exiting from a linear light source. According to the implement of the invention, since the light rays exiting the light guide plate 10 propagate at a narrow range of azimuth angles, the luminance efficiency in the normal direction of the light outputting surface of the light guide plate 10 is excellent, and the backlight module incorporating the light guide plate 10 has high luminance efficiency as a result. Moreover, since only one optical film 30 is needed in the light guide plate 10 to deflect light rays, a thinner backlight module compared to the conventional one that uses two prism sheets can be obtained, and thus the manufacturing cost is reduced.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. For example, the shape of the grooves formed on the light guide plate includes, but is not limited to, a V shape. The grooves only have to be formed parallel to each other and serve to narrow the azimuth angles of light propagation directions, and their shapes are not restricted. Therefore, the scope of the appended claims should be accorded the broadest interpretation so as to encompass all such modifications and similar arrangements.

What is claimed is:

1. A backlight module, comprising:
a light guide plate having a light outputting surface and a light reflecting surface opposing to the light outputting surface, wherein the light outputting surface is provided with a plurality of dots, and the light reflecting surface is provided with a plurality of grooves parallel to each other; and
at least one point light source provided on the light guide plate and next to the ends of the grooves, the emitting light rays of the point light source being guided by the grooves to have the propagation directions of most of the light rays propagating in the light guide plate to be parallel to the direction of the grooves.

2. The backlight module as claimed in claim 1, wherein the backlight module further comprises an optical film provided neighboring the light outputting surface of the light guide plate, the surface of the optical film facing the light outputting surface being provided with a plurality of refraction elements arranged in a direction perpendicular to the direction of the grooves.

3. The backlight module as claimed in claim 2, wherein the grooves are V-shaped in cross-section and the refraction elements are prismatic structures.

4. The backlight module as claimed in claim 3, wherein the vertex angle of each V-shaped groove is from 80 degrees to 120 degrees.

5. The backlight module as claimed in claim 1, wherein each of the dots has a rectangular light incident surface facing the point light source.

6. The backlight module as claimed in claim 1, wherein each of the dots has an arc-shaped light incident surface facing the point light source, and the arc angle of the arc-shaped light incident surface is smaller than 20 degrees.

7. The backlight module as claimed in claim 1, wherein the distribution density of the dots increases along the direction away from the point light source.

8. The backlight module as claimed in claim 1, wherein the backlight module has a plurality of point light sources, and all the point light sources are provided on the same side of the light guide plate.

9. The backlight module as claimed in claim 1, wherein a V-shaped planar zone without the grooves is defined on the light reflecting surface of the light guide plate, and the apex of the V-shaped planar zone is close to the point light source.

10. The backlight module as claimed in claim 9, wherein the vertex angle of the V-shaped planar zone is from 90 degrees to 100 degrees.

11. The backlight module as claimed in claim 1, wherein a V-shaped densely-dot-distributed zone having higher dot distribution density compared to its neighboring zone is defined on the light outputting surface of the light guide plate, and the apex of the V-shaped densely-dot-distributed zone is close to the point light source.

12. The backlight module as claimed in claim 11, wherein the vertex angle of the V-shaped densely-dot-distributed zone is from 90 degrees to 100 degrees.

13. The backlight module as claimed in claim 1, wherein a V-shaped sandblasting zone is defined on the light outputting surface of the light guide plate, and the apex of the V-shaped sandblasting zone is close to the point light source.

14. The backlight module as claimed in claim 13, wherein the vertex angle of the V-shaped sandblasting zone is from 90 degrees to 100 degrees.

15. The backlight module as claimed in claim 1, wherein a plurality of notches are formed on the light outputting surface of the light guide plate and arranged in a direction parallel to the direction of the grooves.

16. The backlight module as claimed in claim 15, wherein the notches are V-shaped in cross-section.

17. A light guide plate, comprising:
a light outputting surface;
a plurality of dots arranged on the light outputting surface;
a light reflecting surface opposing to the light outputting surface; and
a plurality of grooves formed parallel to each other on the light reflecting surface, and the ends of the grooves being positioned next to at least one light source to guide emitting light rays of the light source to propagate to the whole light guide plate at a narrow range of azimuth angles.

18. The light guide plate as claimed in claim 17, wherein the grooves are V-shaped in cross-section.

19. The light guide plate as claimed in claim 18, wherein the vertex angle of each V-shaped groove is from 80 degrees to 120 degrees.

20. The light guide plate as claimed in claim 17, wherein each of the dots has a rectangular light incident surface facing the light source.

21. The light guide plate as claimed in claim 17, wherein the dots have an arc-shaped light incident surface facing the light source, and the arc angle of the arc-shaped light incident surface is smaller than 20 degrees.

22. The backlight module as claimed in claim 17, wherein the distribution density of the dots increases along the direction away from the light source.
